(19) United States
(12) Patent Application Publication
(10) Pub. No.: US 2007/0051166 A1
(43) Pub. Date: Mar. 8, 2007

(54) Leak detection systems and methods

(76) Inventors: Kenneth R. Baker, Cypress, TX (US); Abdlmonem H. Beitelmal, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/219,040

(22) Filed: Sep. 2, 2005

(51) Int. Cl. G01M 3/28

(52) U.S. Cl. 73/40.5 R

(57) ABSTRACT

Systems, methodologies, and other embodiments associated with fluid leak detection are described. One exemplary system embodiment includes a leak detection jacket that is configured to change properties when contacted by fluid.

### BACKGROUND

Power consumption in electrical devices like computer servers continues to rise each year. It is becoming more difficult to provide sufficient air to cool the servers. One alternative is to use fluid cooling systems. However, when using water or other fluids to cool electrical components (e.g. a microprocessor), fluid leaks can be potentially damaging to the system. Furthermore, detecting leaks at plumbing junctions or other areas becomes more difficult because the leak may be small (e.g. a drip).

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example embodiment of a leak detection system.

FIG. 2 illustrates an example embodiment of a control logic for a leak detection system.

FIG. 3 illustrates one example cross-section embodiment of a fluid tubing having leak detection layers disposed thereon.

FIG. 4 illustrates one embodiment of a server connected to a liquid cooled recirculation system that uses the example leak detection tubing of FIG. 3.

FIG. 5 illustrates one example embodiment of the server of FIG. 4 having leak detection jackets and control logic.

FIG. 6 illustrates one embodiment of a methodology that can be associated with detecting a leak.

FIG. 7 illustrates one embodiment of a methodology that can be associated with detecting a leak and responding to the leak.

### DETAILED DESCRIPTION

Example systems, methods, and other embodiments described herein relate to fluid leak detection as well as management of a leak. In one embodiment, the example systems and methods are directed to leak detection for cooling systems that use fluid to cool electrical components. For example, in a liquid cooled rack that contains one or more servers, liquid detection jackets can be wrapped around connection ports (e.g. plumbing junctions) in order to sense fluid leaks. Each leak detection jacket can be configured with various layers that have known electrical properties in dry conditions. In the event of a leak, fluid will contact a leak detection jacket and change its electrical properties. In one example, the capacitance of the jacket changes. A control logic can be configured to sense or otherwise measure the electrical properties of each leak detection jacket to determine whether a leak has occurred. If a leak is detected, the control logic can be configured to respond in a variety of ways.

In one example, the control logic can generate an alert signal. In another embodiment, the control logic can transmit an alert signal to one or more servers that may be affected by the leak where the alert signal causes the one or more servers to safely shut down before the leak may cause damage and/or cause loss of data.

In another embodiment, the control logic can be configured to generate the alert signal and attempt to contain the fluid leak by automatically shutting off one or more valves that are upstream from the detected leak in the fluid tubing. In this embodiment, the configuration would include one or more electrically controlled valves within the fluid tubing that allows for the valve to be selectively opened or closed.

It will be appreciated that the example systems and methods herein are also applicable to and can be used in a variety of environments rather than a liquid cooled rack. For example, the leak detection systems and methods can be implemented in any device that involves a fluid cooled system for electrical components like an automobile, an aircraft, a ship, a spacecraft, a submarine, as well as a building with a computer room. It will also be appreciated that the example leak detection systems and methods are not limited to cooling systems but also heating systems that may be used to maintain the temperature of electrical components in low heat conditions such as high altitude aircraft, spacecraft, arctic environments, and the like. The example leak detection systems and methods may also be implemented with fluid carrying systems that carry fluid without involving a heat transfer.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer communication”, as used herein, refers to a communication between two or more devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, semiconductor memories, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a hard disk, a magnetic tape, other magnetic medium, a CD-ROM, other optical medium, a RAM (random access memory), a ROM (read only memory), an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be considered to be operably connected if they are able to communicate signals to each other directly or through one or more intermediate entities like a processor, an operating system, a logic, software, or other entity. Logical and/or physical communication channels can be used to create an operable connection, and may include wireless channels.

“Signal”, as used herein, includes but is not limited to one or more electrical or optical signals, analog or digital signals, data, one or more computer or processor instructions, messages, a bit or bit stream, or other means that can be received, transmitted, and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent, for example, on requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Software suitable for implementing the various components of the example systems and methods described herein may include software produced using programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, detecting, calculating, determining, comparing, displaying, or the like, refer to actions and processes of a computer system, logic, processor, or similar electronic device that manipulates and transforms data represented as physical (electronic) quantities.

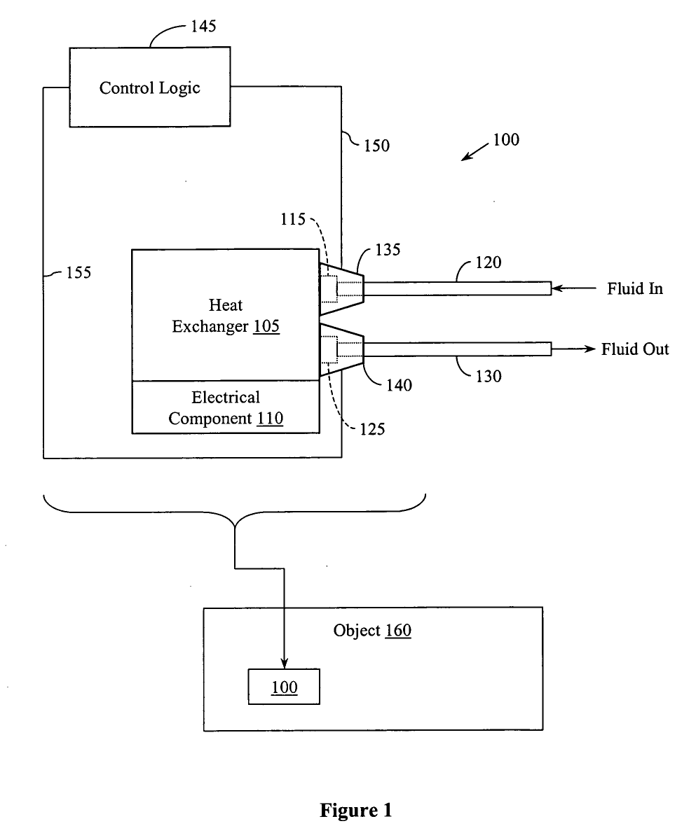

With reference to the figures, illustrated in FIG. 1 is one embodiment of a leak detection system that can be configured to detect fluid leaks in an electronic device and/or in a fluid cooled recirculation system. In one embodiment, the fluid is a liquid. The recirculation system may include a heat exchanger 105 configured to exchange heat with one or more electrical components 110 like a microprocessor. The heat exchanger 105 can include an input connection port 115 that connects with fluid tubing 120, which carries cooled fluid into the heat exchanger 105. The heat exchanger 105 can further include an output connection port 125 that connects to fluid tubing 130, which carries heated fluid out from the heat exchanger 105 and transports the fluid through the recirculation system to be re-cooled.

The connection ports 115 and 125 are plumbing junctions where connections occur with the fluid communication tubes 120 and 130. The components may be connected to each other using quick-disconnect valves or other type of plumbing connectors. At plumbing junctions, there is an increased likelihood of fluid leaks.

In one embodiment of the leak detection system 100, a leak detection jacket (e.g. jacket 135 and/or jacket 140) can be disposed co-axially around the connection ports 115 and 125, respectively. A leak detection jacket will also be referred to as a port wrap because the jacket can be a material that can be wrapped around a port (or tube or other plumbing junction). For example, the leak detection jacket 135 and/or other jackets shown in other figures can have a tube-like form when placed around a selected location. It will be appreciated that the illustrated geometry of the leak detection jackets 135 and 140 are not intended to represent an actual geometry. Rather, the illustrated geometries are only for explanatory purposes and to show a general relationship that the leak detection jackets 135 and 140 are disposed around at least a portion of the connection ports 115 and 125, and/or may be disposed around at least a portion of the fluid communication tubes 120 and 130 or other desired location. Furthermore, the illustrated spacings between components may or may not exist. The foregoing applies to all embodiments and figures herein.

Using leak detection jacket 135 as an example, the jacket 135 is disposed around the connection port 115 to cover at least a portion of a plumbing junction. In one embodiment, the jacket 135 can be placed on or wrapped around the plumbing junction of a pre-existing system and securing the jacket 135 with cable ties, wires, velcro, tapes, adhesive, and the like. In another embodiment, the jacket 135 can be integrally formed as part of the connection port 115 or part of the fluid tubing 120. One example is described with reference to FIG. 3.

With continued reference to FIG. 1, the leak detection jacket 135 can be configured with electrical properties that are changed by contact with fluid. Thus, the jacket 135 can be made to absorb fluid. To detect the change in the electrical properties, a control logic 145 can be operably connected to the leak detection jacket 135 by one or more signal paths 150 such as electrical connections, lead wires, or other type of desired communication channel. The control logic 145 can also be connected to other leak detection jackets such as jacket 140 using one or more signal paths 155. In this manner, the control logic 145 can be configured to detect a fluid leak at the connection ports 115, 125 by detecting a change in the electrical properties of selected leak detection jackets (e.g. jackets 135 and 140).

In one embodiment, the control logic 145 can be configured to detect a change in capacitance in the leak detection jackets 135, 140. The control logic 145 can also be configured with other types of circuitry, and/or sensors to detect changes in other electrical properties like resistance, impedance, and/or voltage. In one example, values for the selected electrical property like capacitance can be pre-measured for the detection jacket 135 when the jacket 135 is in a dry condition. This may include an acceptable range of capacitance values that indicate a dry condition.

When fluid is being circulated, the control logic 145 can measure the capacitance of the detection jacket 135 and compare the measured capacitance value with the pre-measured capacitance values for dry conditions to determine whether fluid has contacted the detection jacket 135. If the measured value falls outside the acceptable range, the presence of a fluid leak is assumed and an alert signal can be generated.

In another embodiment, the leak detection jackets 135, 140 can be configured as fluid containment jackets that are disposed around the connection ports 115, 125 respectively. As a containment jacket, the jacket is configured to contain a fluid leak. In one example, the jackets 135,140 can be configured with an outer layer that is fluid impermeable.

In another embodiment, the control logic 145 can be configured to identify a location of a fluid leak based on identifying which of the leak detection jackets 135, 140 exhibits the change in its electrical properties. For example, the signals received on signal paths 150 and 155 can be associated with each particular detection jacket 135 or 140. If a change in electrical properties occurs on signal path 150, the control logic 145 can identify the location of the fluid leak as being at jacket 135. This feature can be used in other embodiments where electrically controlled valves are present in the system that can be automatically shut off to prevent fluid from continuously feeding the location of the leak. This will be described in greater detail below. Additionally, by identifying the location of a leak, the control logic 145 can be configured to alert a particular electrical component like a server to take preventative measures before a leak may cause damage. In one embodiment, the server can be instructed to gracefully shutdown and then the appropriate valves can be closed. In this sequence, overheating of the server is reduced since the server continues to be cooled. Of course, the reverse sequence can be performed if desired.

As previously explained, the leak detection system 100 can be implemented in any object 160 that involves a fluid carrying system like an automobile, an aircraft, a ship, a spacecraft, a submarine, as well as a building.

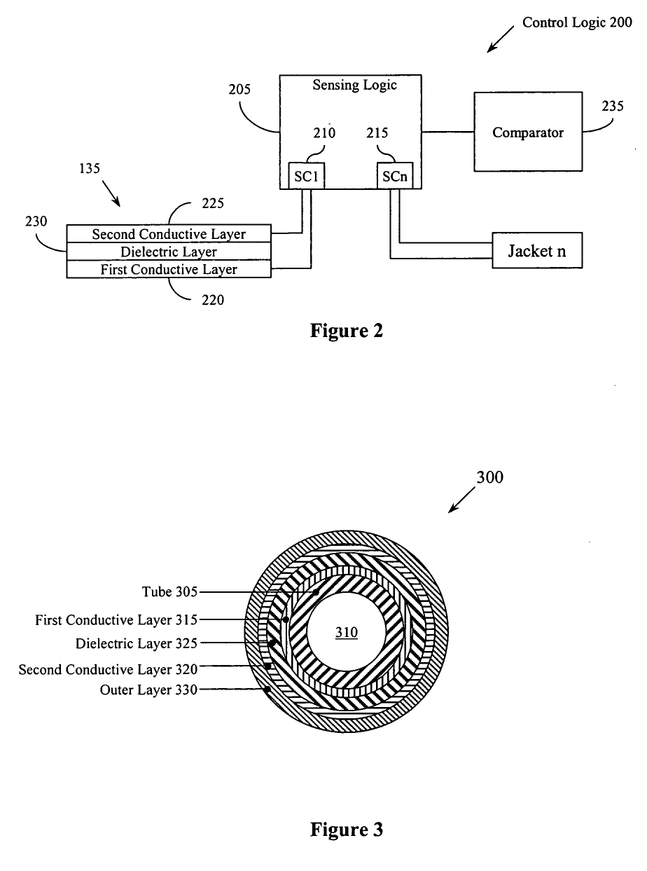

Illustrated in FIG. 2 is one embodiment of a control logic 200 that may be implemented for the control logic 145 shown in FIG. 1. The control logic 200 can include a sensing logic 205 that may comprise one or more sensing circuits 210, 215, which are identified as sensing circuits SC1 . . . SCn. Each sensing circuit 210, 215 can be configured to sense the electrical properties of a selected leak detection jacket. For example, sensing circuit 210 (SC1) is connected to jacket 135 and sensing circuit 215 (SCn) is connected to jacket n.

Of course, one circuit can be connected to function with multiple jackets. For example, multiple signal lines from multiple jackets can be sensed together where if a change in electrical properties occurs in any one jacket, a leak is detected. In one embodiment, AND gates can be connected to multiple sensing lines from multiple jackets so that a value change in one line triggers an alert signal. In another embodiment, the control logic 200 can be configured to identify each jacket in order to specifically locate a leak, which is described in other examples.

With further reference to FIG. 2, the jacket 135 is illustrated as an example embodiment comprising layers that form the jacket 135. For example, the jacket 135 can include first and second electrically conductive layers 220 and 225 that are separated by a dielectric layer 230. The sensing circuit 210 can be electrically connected to the first conductive layer 220 and the second conductive layer 225 as a way to measure the electrical properties of the jacket 135. In one example, an electrode or other type of electrical connecting device can be in contact with the first conductive layer 220, which then connects to a lead line or wire that is connected to the sensing circuit 210. The second conductive layer 225 can be similarly connected.

The conductive layers 220, 225 can be, for example, braided metal, copper, steel, aluminum, metalized fabric, or other type of electrically conductive material. The conductive layers 220 and 225 and the dielectric layer 230 can be fluid permeable so that fluid that contacts one of the conductive layers will be absorbed to come into contact with the dielectric layer 230. By separating the conductive layers 220, 225 with the dielectric layer 230, a natural capacitor is created. Thus, when fluid comes into contact with the layers, the capacitance changes, indicating a wetted condition.

In one embodiment, the sensing circuit 210 can be configured to measure the capacitance between the first and second conductive layers 220 and 225 where the presence of fluid will change the capacitance level. A comparator 235 can include logic that compares the measured capacitance value from the sensing circuit 210 to a predetermined capacitance value or range of values that were previously measured and known for a dry condition of the fluid detection jacket 135. The previously measured dry values can be maintained in and retrieved from a data store. If the measured capacitance value falls outside the dry condition range, the sensing logic 205 can generate an alert signal. Using the jacket 135, even small amounts of fluid (e.g. a drip class) can cause a change in capacitance and can be detected.

In another embodiment for detecting a wetted condition, depending on how the sensing circuit 210 is configured, the presence of fluid may cause a circuit to open or close between the first conductive layer 220 and the second conductive layer 225 to indicate the presence of fluid.

Illustrated in FIG. 3 is one example embodiment of a cross-section view of a fluid tubing 300 that is enclosed with layers of a leak detection jacket as described in FIG. 2. The layers of the jacket may be wrapped around a preexisting fluid communication tube 305 such as by retrofitting on the tube 305 or the jacket layers can be integrally formed as part of the fluid tube 305. The leak detection jacket can be in direct contact with the fluid tube 305. The tube 305 defines an internal fluid path or channel 310.

The layers of the jackets include a first conductive layer 315, a second conductive layer 320, which are disposed around the tube 305, and have a dielectric layer 325 positioned between them to provide electrical insulation. In one embodiment, layers 315, 320, and 325 can be similar to the first conductive layer 220, the second conductive layer 225, and the dielectric layer 230, respectively, as described with reference to FIG. 2. The jacket layers may also include an optional outer layer 330 that can serve as a protective layer. The outer layer 330 can also be a fluid containment layer if formed with a fluid impermeable material. It will be appreciated that the illustrated sizes of the layers and size relationships between the layers are not drawn to scale.

In one example embodiment, the tube 305 can be an elongated tube body defining the internal fluid path 310 for allowing a fluid to flow therethrough. The first conductive layer 315 can be electrically conductive and encloses at least a portion of the elongated tube body 305. The dielectric layer 325 can be disposed around the first electrically conductive layer 315 and the second electrically conductive layer 320 is disposed around the dielectric layer 325. The first and second electrically conductive layers 315, 320 are configured to connect to a sensing circuit configured to sense a capacitance change between the first and second electrically conductive layers due to a fluid leak from the tube 305 that contacts the first electrically conductive layer.

In another embodiment, the jacket 135 or tube 305 can include multiple sets of the conductive layers 220, 225 (or layers 315, 320) each separated by a dielectric layer and stacked on each other. In this manner, each pair of conductive layers acts as a leak sensor and can be used to determine an extent of a leak. For example, suppose a first pair of conductive layers are layers 220, 225 that are placed adjacent the fluid tube and a second pair of conductive layers are placed on top of layers 220, 225. If the first pair of conductive layers that are closest to the fluid tube detect a leak but the second pair does not, then the system knows that the leak did not reach the second pair of conductors and thus the leak did not breach the exterior of the jacket 135 or the tube 305. If the second pair detects the leak, then system can assume that the leak is more severe.

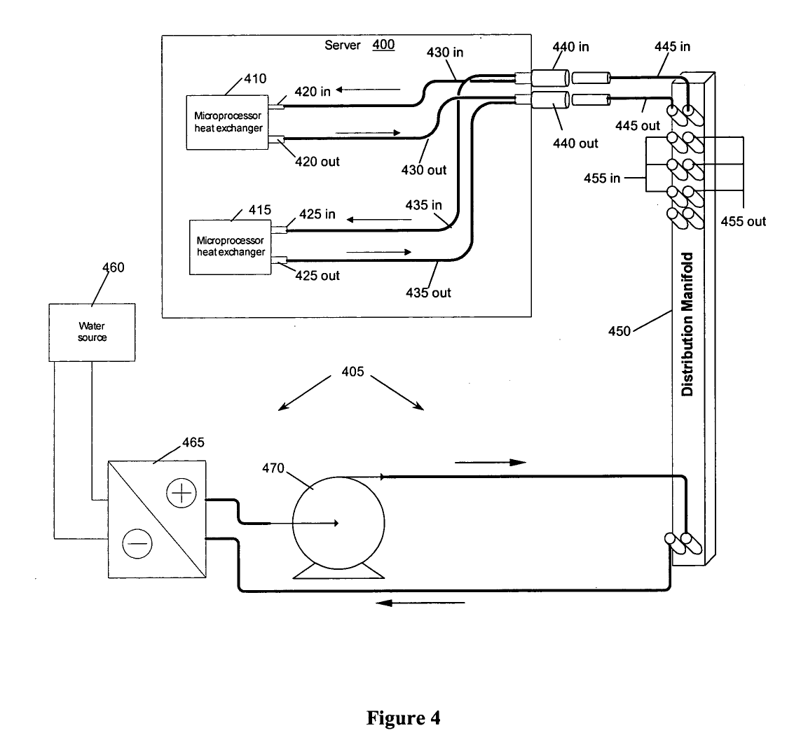

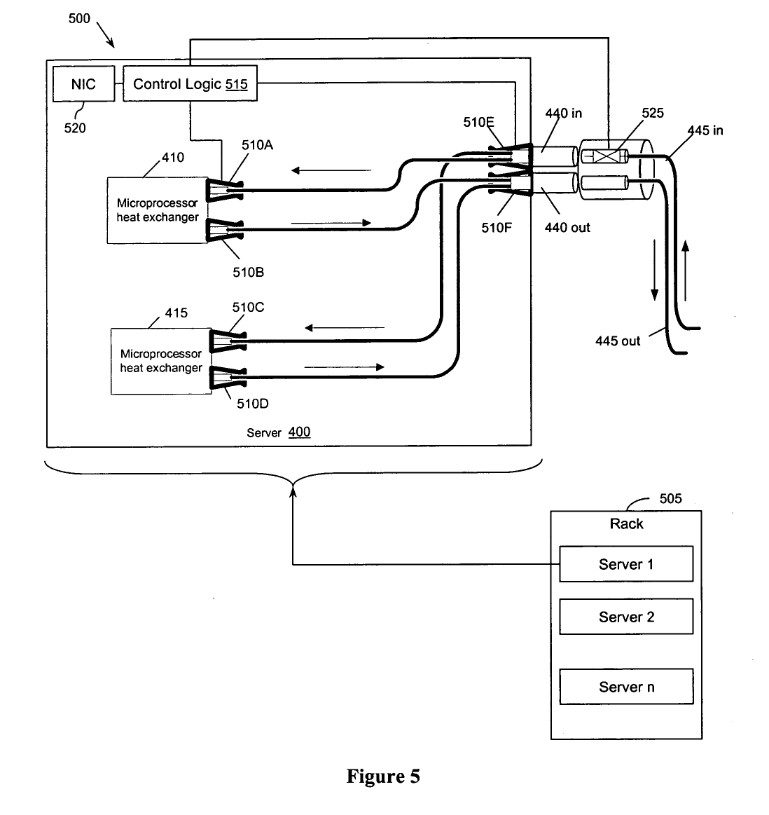

Illustrated in FIG. 4 is one example embodiment of a server 400 connected to a fluid re-circulation system 405 that can include one or more fluid tubes that are formed using the example leak detection tubing 300 shown in FIG. 3. The diagram will be used as an example for implementing a leak detection system thereon, which will be described in FIG. 5. It will be appreciated that different configurations exist for the re-circulation system 405. For example, one embodiment includes having the system 405 provide cooling on a server level where the fluid tubing and heat exchanger are internal to the server 400 as illustrated in FIG. 4. In another embodiment, the system 405 can provide cooling on a rack level where the fluid tubing and heat exchanger are not internal to the server 400 but connected to a rack or other type of component cabinet. Cooling liquid is used to cool air in the rack and the cooled air is then forced though the rack to cool servers or other components within the rack.

With reference to FIG. 4, the server 400 is shown with two microprocessor heat exchangers 410 and 415 that are configured to transfer heat between microprocessors within the server 400. Each heat exchanger includes a fluid input connection port 420in and 425in, respectively, and a fluid output connection port 420out and 425out, respectively. Fluid tubes 430in and 435in carry fluid into the heat exchanger 410, 415, respectively, and fluid tubing 430out, 435out carry the fluid out. The server 400 can include an input connection port 440in and a fluid output connection port 440out that are configured to easily connect to fluid tubing 445in and 445out from the external re-circulation system 405.

The re-circulation system 405 can include a distribution manifold 450 that may include one or more fluid input connection ports 455in and fluid output connection ports 455out. The distribution manifold 450 can be used to connect to multiple servers to provide cooling fluid.

The re-circulation system 405 can include a water source 460 (e.g. a chiller) or other type of fluid to be used in the heat exchange to provide fluid to a system heat exchanger 465 in a fluid cooling system. The system heat exchanger 465 is configured to cool the fluid before the fluid is carried to a re-circulation pump 470 that circulates the fluid into the distribution manifold 450. Thus, the system includes fluid tubing that defines an input path into the heat exchanger 465 and an output path from the heat exchanger 465 and out from the pump 470. Once the fluid is heated within one of the microprocessor heat exchangers 410, 415, the fluid ultimately returns to the system heat exchanger 465 to be re-cooled and re-circulated.

Illustrated in FIG. 5 is one embodiment of a leak detection system implemented with the server 400 shown in FIG. 4. Components that are common to both figures have the same reference numbers. The server 400 can be one of many servers that are part of a computer rack 505 or other type of computer equipment cabinet. The system can be operably configured within a motor vehicle, an aircraft, a spacecraft, a ship, or a building. The leak detection system 500 includes one or more leak detection jackets or port wraps 510A-510F. The port wraps 510A-510F are wrapped around selected ports/plumbing junctions and can include similar layers as the leak detection jacket 135 shown in FIGS. 1 and 2.

The leak detection system 500 can include a control logic 515 that is configured similar to the control logic 145 of FIG. 1 or the control logic 200 of FIG. 2. The control logic 515 can be connected to selected port wraps 510A-510F by being connected to the conductive layers of each port wrap. To simplify the diagram of FIG. 5, the control logic 515 is only shown to be connected to port wraps 510A and 510E with connection lines.

The control logic 515 can be configured to measure an electrical property of the two electrically conductive layers from a port wrap where a change in the electrical property is used to determine if fluid is in contact with the port wrap 510A, 510E which indicates a fluid leak. If a change in the electrical property (e.g. changing capacitance) occurs, a fluid leak is presumed and an alert signal can be generated. The alert signal can be transmitted to a communication device such as a network interface card (NIC) 520. The NIC 520 can use computer communications to transmit the alert signal to a server or other management control system such that a server that is associated with the fluid leak can be alerted.

As previously described as an example for identifying the location of a leak, each port wrap 510A-510F can be identifiable by the control logic 515 such that the control logic 515 can determine a location of the fluid leak by identifying the port wrap having the change in the electrical property. Based on the location of the leak, an identified server can receive an alert signal that can cause the server to safely shut down affected components and/or shut down entirely. For example, if a fluid leak is detected in port wrap 510A, server 400 can receive a signal to shut down a microprocessor that is associated with the microprocessor heat exchanger 410. In this manner, the server 400 may be able to continue processing with other microprocessors so that loss of service can be minimized.

In another embodiment, the fluid connection ports such as connection ports 440in and 440out can be connected with quick disconnect valves that include an electronically controlled valve 525. If a leak is detected within port wrap 510A or 510E, which affects the heat exchanger 410, the control logic 515 can be configured to automatically turn off the valve 525 to prohibit further fluid from being carried along the path where the leak has occurred. In this manner, potential damaged caused by leaking fluid can be reduced.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various actions occurring in serial, it is to be appreciated that in different examples, various actions could occur concurrently, substantially in parallel, and/or at substantially different points in time.

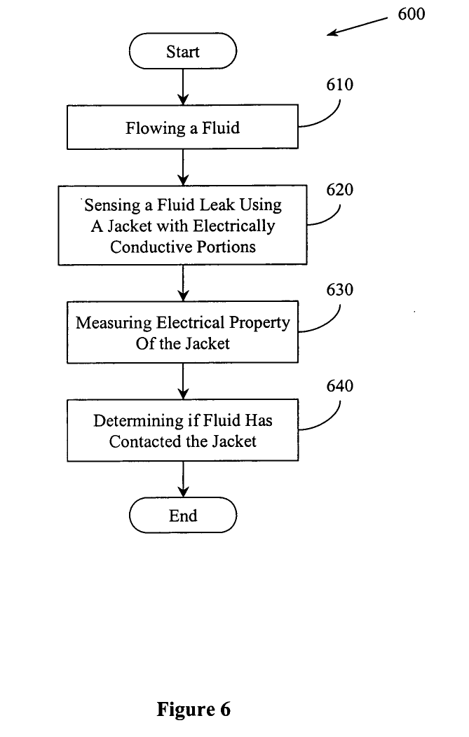

FIG. 6 illustrates an example methodology 600 associated with fluid leak detection. The illustrated elements denote “processing blocks” that may be implemented in logic. In one example, the processing blocks may represent executable instructions that cause a computer, processor, and/or logic device to respond, to perform an action(s), to change states, and/or to make decisions. Thus, described methodologies may be implemented as processor executable instructions and/or operations provided by a computer-readable medium. In another example, processing blocks may represent functions and/or actions performed by functionally equivalent circuits like an analog circuit, a digital signal processor circuit, an application specific integrated circuit (ASIC), or other logic device. The figures are is not intended to limit the implementation of the described examples. Rather, the figures illustrate functional information one skilled in the art could use to design/fabricate circuits, generate software, or use a combination of hardware and software to perform the illustrated processing.

Illustrated in FIG. 6 is one example embodiment of a methodology 600 that can be associated with a fluid cooled system and detecting a fluid leak. The methodology 600 can include flowing a fluid through tubing connected to a heat exchanger (Block 610). The tubing can be connected at one or more locations at connection ports. A fluid leak can be sensed at selected connection ports using a jacket that axially surrounds the selected connection port (620). The jacket can have electrically conductive portions and can be fluid permeable where upon contact with the fluid, an electrical property of the jacket is changed. This can include sensing a change in capacitance between conductive layers in the jacket as described in previous embodiments. The method 600 can also include measuring the electrical property of the jacket (Block 630) and determining whether fluid has contacted the jacket based on a change in the electrical property which indicates a fluid leak (Block 640).

In one embodiment, the determining Block 640 can include comparing the measured electrical property with a predetermined value for the electrical property to determine whether a change has occurred in the electrical property. As explained in a previous example, electrical property values can be pre-measured that represent a dry condition. Based on a desired sensing circuit, the electrical property can include capacitance, resistance, voltage, impedance, or other desired property. In other embodiments, changes in temperature or pressure can also be detected.

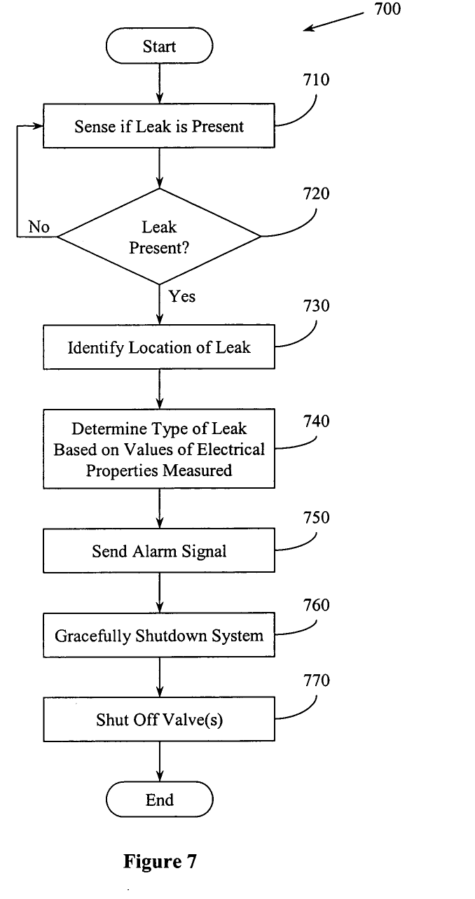

Illustrated in FIG. 7 is one embodiment for an example methodology 700 that can be associated with detecting a leak and taking appropriate actions. The example methodology 700 can be implemented with the example control logics 145, 200, or 515 or other systems. Once initiated, the methodology 700 can sense whether a fluid leak is present (Block 710). The sensing can be performed continuously or periodically like at an interval (e.g. every minute or other time period). The sensing can include measuring electrical properties of leak detection jackets that are positioned at various points in a fluid carrying system as previously described. In one embodiment, block 710 can be implemented similar to block 640 discussed with reference to FIG. 6. If a leak is not detected at block 720, the method returns to block 710 for the next sensing.

If a leak is detected at block 720, the location of the leak can be identified (Block 730). As previously explained, each leak detection jacket can be uniquely identifiable. The method can also determine the type of leak, for example, based on the values of the electrical properties measured (Block 740). For example, if a change in capacitance is being measured, a small change may indicate a small leak (e.g. a drip). Alternately, a large change in capacitance may indicate a large leak (e.g. liquid passes through the leak detection jacket). Similar implementations can be used for measuring other electrical properties like changes in voltage and others.

At block 750, an alarm signal can be sent to appropriate systems, servers, or other components that a fluid leak has been detected. The alarm signal can cause the systems or servers to gracefully shutdown (Block 760) to reduce any potential damage from the leak. If automatically controlled values are present in the system, appropriate values can be shut off to stop the leak from progressing (Block 770). At this point, the method can end or return to block 710 to continue sensing for other systems or servers that may still be operating.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

1. A leak detection system for a system that includes fluid communication tubes configured to transport a fluid to and from one or more heat exchangers positioned adjacent to one or more electrical components within the system, where the fluid communication tubes are connected to one or more connection ports, the leak detection system comprising:
a leak detection jacket disposed co-axially around the one or more connection ports, the leak detection jacket being configured with electrical properties that are changed by contact with fluid; and
a control logic operably connected to selected leak detection jackets, the control logic being configured to detect a fluid leak at the one or more connection ports by detecting a change in the electrical properties of a selected leak detection jacket.

2. The system of claim 1, the control logic being configured to detect a change in capacitance in the leak detection jacket.

3. The system of claim 1, where the leak detection jacket comprises two electrically conductive layers separated by a dielectric layer, the two electrically conductive layers and the dielectric layer being axially disposed around portions of the fluid communication tubes and the one or more connection ports.

4. The system of claim 1, where the leak detection jacket is configured as a containment jacket around a connection port.

5. The system of claim 1 further comprising:
one or more valves operably connected to the fluid communication tubes where the one or more valves are electrically controlled to allow or prohibit flow of the fluid; and
the control logic being configured to automatically shut off a selected valve from the one or more valves in response to detecting a fluid leak at a corresponding leak detection jacket.

6. The system of claim 1, the control logic being configured to identify a location of the fluid leak based on identifying which of the leak detection jackets exhibits the change in its electrical properties.

7. The system of claim 1 where the system is operably connected to a computer rack that contains the computing system, and where the one or more electrical components include one or more processors.

8. The system of claim 1 where the leak detection jacket extends beyond the connection port and is formed integral with at least a portion of the fluid communication tube.

9. The system of claim 1 where the controller is configured to transmit a signal to the computing system that causes the computing system to safely shut-down electrical components that are affected by the fluid leak in response to a detected fluid leak.

10. The system of claim 1 where the system is configured within an object that contains the system, the object being a motor vehicle, an aircraft, a spacecraft, a ship, or a building.

11. A system, comprising:
a fluid recirculation system comprising fluid tubing for carrying a fluid, a pump for pumping the fluid through the fluid tubing, and a system heat exchanger connected to the fluid tubing for exchanging heat with the fluid, the fluid tubing defining an input path into the heat exchanger and an output path from the heat exchanger;
a computer equipment cabinet configured with a plurality of servers, and including at least one fluid input port and at least one fluid output port for connecting with the fluid tubing of the fluid recirculation system;
a component heat exchanger configured to exchange heat between one or more electronic components within a server and the fluid, where the fluid tubing connects the component heat exchanger to the at least one fluid input port and the at least one fluid output port;
a port wrap being fluid permeable and being wrapped around selected ports from the at least one fluid input port and the at least one fluid output port, the port wrap being configured with at least two electrically conductive layers separated by a dielectric layer; and
a control logic operably connected to the electrically conductive layers of the port wrap, the control logic being configured to measure an electrical property using the two electrically conductive layers where a change in the electrical property is indicative of a fluid leak.

12. The system of claim 11 where the port wrap further includes an outer layer that is fluid impermeable.

13. The system of claim 11 where the port wrap extends around the selected port and along a portion of the fluid tubing connected to the selected port.

14. The system of claim 11 where the control logic is configured to compare the measured electrical property of the two conductive layers to a predetermined value that represents a dry condition.

15. The system of claim 11 further including a communication interface operably connected to the control logic where the control logic is configured to generate an alert signal when the fluid leak is detected and the communication interface is configured to transmit the alert signal to a server that is associated with the fluid leak.

16. The system of claim 11 where each of the port wraps are identifiable by the control logic such that the control logic is configured to determine a location of the fluid leak by identifying the port wrap having the change in the electrical property.

17. The system of claim 16 where the control logic is configured to transmit an alert signal to an identified server based on the location of the fluid leak, and causing the identified server to safely shutdown affected components.

18. The system of claim 16 further including one or more fluid valves positioned along the fluid tubing, the control logic being configured to cause the one or more fluid values to close based on the location of the fluid leak.

19. The system of claim 11 where the port wrap is a jacket co-axially disposed around the selected ports.

20. The system of claim 11 where the electrical property is capacitance, resistance, impedance, or voltage.

21. The system of claim 11 where the system is operably configured within a motor vehicle, an aircraft, a spacecraft, a ship, or a building.

22. A method, comprising:
flowing a fluid through tubing connected to a heat exchanger, the tubing being connected to one or more locations at connection ports;
sensing a fluid leak at a selected connection port using a jacket that surrounds the selected connection port, the jacket having electrically conductive portions and being fluid permeable where upon contact with the fluid, an electrical property of the jacket is changed;
measuring the electrical property of the jacket; and
determining whether fluid has contacted the jacket based on a change in the electrical property which indicates a fluid leak.

23. The method of claim 22 where the measuring includes measuring a change in capacitance as the electrical property.

24. The method of claim 22 where the determining includes comparing the measured electrical property with a predetermined value for the electrical property to determine if a change has occurred.

25. A tube for carrying a fluid for a heat exchanger, the tube comprising:
an elongated tube body defining an internal fluid path for allowing a fluid to flow therethrough;
a first electrically conductive layer enclosing at least a portion of the elongated tube body;
a dielectric layer disposed around the first electrically conductive layer;
a second electrically conductive layer disposed around the dielectric layer;
the first electrically conductive layer and the second electrically conductive layer being configured to connect to a sensing circuit configured to sense a capacitance change between the first and second electrically conductive layers due to a fluid leak from the tube that contacts the first electrically conductive layer.

26. A leak detection system for a computing system that includes fluid communication tubes configured to transport a fluid to and from one or more heat exchangers positioned adjacent to one or more electrical components within the computing system, where the fluid communication tubes are connected to one or more connection ports, the leak detection system comprising:
a means for absorbing a fluid, the means for absorbing being disposed co-axially around the one or more connection ports, the means for absorbing being configured with electrical properties that are changed by contact with a fluid; and
a means for detecting a leak being operably connected to selected means for absorbing a fluid, the means for detecting being configured to detect a fluid leak at the one or more connection ports by detecting a change in the electrical properties of a selected means for absorbing a fluid.

27. The leak detection system of claim 26 where the means for absorbing includes one or more pairs of electrically conductive layers separated by a dielectric layer.

28. The leak detection system of claim 26 where the fluid is a liquid.
